(19) United States
(12) Patent Application Publication
(10) Pub. No.: US 2011/0163210 A1
(43) Pub. Date: Jul. 7, 2011

(54) Adjustable turnbuckle fire hydrant water meter stand

(76) Inventor: Arthur Hendey, SR., Beaumont, CA (US)

(21) Appl. No.: 12/655,485

(22) Filed: Jan. 4, 2010

(51) Int. Cl. F16M 11/28; F16M 11/04

(52) U.S. Cl. 248/125.8; 248/161; 248/404

(57) ABSTRACT

An adjustable stand to be detachably connected to and provide vertical support for a conventional water meter of the kind that is coupled to a fire hydrant to measure the volume of water consumed by a user by way of the fire hydrant. The water meter stand includes a foot that lays upon the ground and a meter support plate that is attached to the fire hydrant water meter. A turnbuckle assembly is located between the foot and the meter support plate. A housing of the turnbuckle assembly is rotated to cause upper and lower threaded rods to correspondingly move through the housing. Accordingly, the length of the stand between the foot and the meter support plate can be selectively adjusted regardless of the dimensions of the fire hydrant and the elevation of the water meter coupled thereto and suspended above the ground.

### BACKGROUND OF THE INVENTION

1. Field of the Invention

This invention relates to a stand to be coupled to and provide vertical support for a conventional water meter of the kind used to measure the consumption of water by way of a fire hydrant. A turnbuckle is included which can be manipulated to selectively adjust the vertical length of the stand between the water meter and the ground above which the meter is suspended.

2. Background Art

When building contractors are in need of water for use at a construction site, it is not uncommon to purchase the required supply from a municipality or a public utility. A common technique for providing a supply of water to the construction site is to fill a tanker truck by means of a fire hydrant. In order to determine the payment due to the municipality or utility, a water meter is coupled to the fire hydrant to determine the volume of water consumed by the contractor to fill the truck. The greater the volume consumed, the more that is owed by the contractor.

Fire hydrant water meters have a typical length of about 28 inches or more and a typical weight of about 55 pounds or more. With the water meter coupled to the fire hydrant and suspended above the ground, a fire hose, or the like, is attached to the water outlet of the meter. The fire hose and the water which flows therethrough add additional weight which, in combination with other mechanical forces, may cause the water meter to bend at its rigid attachment to the fire hydrant whereby to decrease the flow of water. In some cases, the screw threads between the water meter and the outlet of the fire hydrant could become damaged making detachment and reuse of the meter difficult. In extreme cases, the water meter might simply break off the hydrant. Therefore, it is desirable to be able to locate a stable, reliable support below the fire hydrant to provide a vertical lifting force thereto. Because the terrain on which the fire hydrant is seated may be uneven and/or the dimensions of the fire hydrant may vary from one location to another, a support of fixed length can prove to be ineffective to hold up a water meter when it is coupled to different fire hydrants.

Accordingly, it would be further desirable to have an adjustable vertical support to hold a fire hydrant water meter above the ground regardless of the dimensions of the fire hydrant and the elevation at which the water meter is coupled thereto.

### SUMMARY OF THE INVENTION

In general terms, a stand for a fire hydrant water meter is disclosed to be detachably connected to and provide a vertical lifting force and support for the water meter when the meter is coupled to a fire hydrant. An adjustable turnbuckle is included which can be manipulated (i.e., rotated) relative to the water meter to correspondingly vary the length of the stand between the water meter and the ground above which the water meter is suspended. The adjustable turnbuckle has a housing with threaded collars located at the top and bottom thereof. Upper and lower threaded rods of the adjustable turnbuckle are received by respective ones of the threaded collars. The lower threaded rod is connected to a horizontal turnbuckle foot that is typically affixed (e.g., nailed) to a wooden board laid on the ground below the water meter. The upper threaded rod is located at one end of a turnbuckle mid-assembly. A hollow locking tube which carries a pop-out, snap-in button is located at the opposite end of the turnbuckle mid-assembly.

A hollow upper locking housing has a series of buttonholes formed therein. A meter support plate extends laterally across the top of the upper locking housing. The hollow upper locking housing is sized to slide over and along the locking tube of the turnbuckle mid-assembly until the pop-out button of the tube moves into locking engagement with one of the buttonholes formed in the locking housing. The meter support plate atop the upper locking housing is positioned below the water outlet of the fire hydrant water meter. According to a first preferred embodiment, the support plate is detachably connected directly to the water outlet of the meter by means of bolts. According to another preferred embodiment, a threaded U-bolt is first positioned in surrounding engagement with the water outlet and then mated to the support plate by means of suitable fastening hardware. The length of the water meter stand between the horizontal foot connected to the lower threaded rod of the turnbuckle and the meter support plate at the top of the upper locking housing can be selectively adjusted to compensate for different fire hydrants having different dimensions by rotating one or both of the upper and lower threaded rods within the threaded collars of the turnbuckle housing.

The water meter stand also includes a hollow support bracket sleeve affixed to one end of the meter support plate atop of the upper locking housing. A buttonhole is formed through the support bracket sleeve. A hollow filler tube which carries a pop-out, snap-in button is slidably received within the hollow support bracket sleeve until the pop-out button is moved into locking engagement with the buttonhole. At those times when the water meter stand is not in use, the turnbuckle can be attached to and carried at an out-of-the way location alongside the water meter. In this case, the locking tube of the turnbuckle mid-assembly is separated from the upper locking housing by pushing the pop-out button of the locking tube inwardly of the buttonhole in the upper locking housing. The filler tube is then separated from the support bracket sleeve to be pushed inwardly of and fill the upper locking housing. The locking tube of the turnbuckle is now pushed inwardly through the support bracket sleeve at which the turnbuckle is retained until the water meter stand is once again deployed.

### BRIEF DESCRIPTION OF THE DRAWINGS

FIG. 1 is an exploded view of an adjustable turnbuckle fire hydrant water meter stand according to a preferred embodiment of this invention;

FIG. 2 shows the stand of FIG. 1 detachably connected according to one preferred embodiment to a conventional water meter that is coupled to a fire hydrant;

FIG. 3 shows the stand of FIG. 1 detachably connected according to another preferred embodiment to a different water meter that is coupled to a fire hydrant;

FIG. 4 shows the water meter stand of FIG. 1 detached from the fire hydrant water meter of FIG. 2 during periods of non-use and carried alongside the water meter;

FIG. 5 is an enlarged detail taken from FIG. 4; and

FIG. 6 is another view showing the water meter stand detached from the fire hydrant water meter and carried alongside the water meter.

### DESCRIPTION OF THE PREFERRED EMBODIMENT

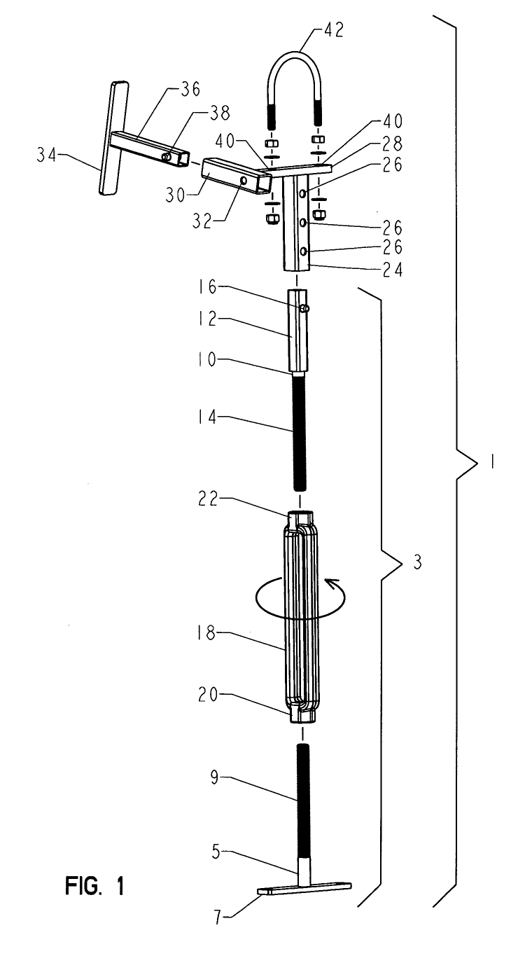

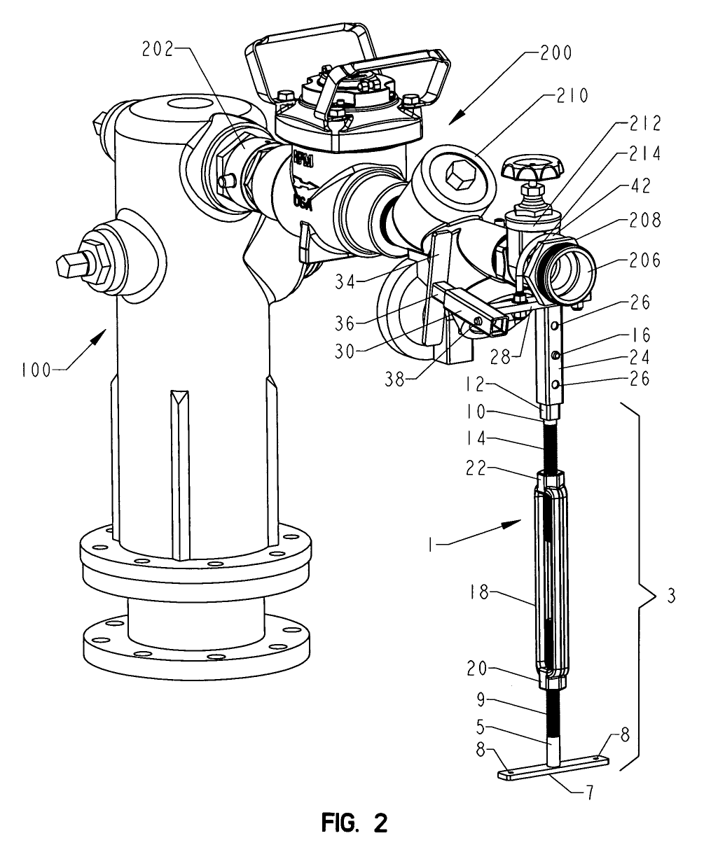

FIG. 1 of the drawings shows an adjustable turnbuckle fire hydrant water meter stand 1 for use with a fire hydrant water meter according to a first preferred embodiment of this invention. FIG. 2 of the drawings shows the water meter stand 1 of FIG. 1 detachably connected to a fire hydrant water meter 200 coupled to a fire hydrant 100. Referring first to FIG. 1, the water meter stand 1 includes an adjustable turnbuckle 3 having a variable vertical length that is capable of providing a corresponding variable vertical lifting force for supporting the water meter 200 regardless of the dimensions of the water meter 200 and the elevation above the ground at which the water meter is coupled to the fire hydrant 100.

The water meter stand 1 includes a cylindrical turnbuckle base 5. A horizontal foot 7 extends across the bottom of the turnbuckle base 5, and a lower threaded rod 9 is welded to and extends upwardly from the base 5. The rod 9 is preferably provided with a right-handed thread.

Positioned above the lower threaded rod 9 is a turnbuckle mid-assembly 10. A hollow square locking tube 12 is located at the top of the turnbuckle mid-assembly 10, and an upper threaded rod 14 is welded to and extends downwardly from the mid-assembly 10 so as to lie in spaced axial alignment with the lower threaded rod 9 of the turnbuckle base 5. The upper threaded rod 14 is preferably provided with a left-handed thread. A spring-actuated, pop-out snap-in button 16 extends outwardly from the locking tube 12.

Located between the axially-aligned lower and upper threaded rods 9 and 14 of the turnbuckle base 5 and the turnbuckle mid-assembly 10 is a hollow turnbuckle housing 18. The turnbuckle housing 18 includes lower and upper threaded collars 20 and 22 at opposite ends thereof within which to rotatably receive respective ones of the lower and upper threaded rods 9 and 14.

An upper locking housing 24 is preferably a hollow tube having a number of axially-aligned buttonholes 26 formed therein. A water meter support plate 28 extends laterally across the top of the locking housing 24. The upper locking housing 24 is sized and shaped to ride over and slidably receive therewithin the locking tube 12 of the turnbuckle mid-assembly 10.

The vertical length of the fire hydrant water meter stand 1 between the foot 7 at one end and the meter support plate 28 at the opposite end can be selectively adjusted by sliding the upper locking housing 24 over the locking tube 12 until the pop-out button 16 of tube 12 is spring-urged to snap into removable receipt by one of the buttonholes 26 formed through the upper locking housing 24 depending upon the particular dimensions of the fire hydrant 100 and the elevation of the water meter 200 coupled to fire hydrant 100. Fine adjustments in the vertical length of the stand 1 can be achieved by rotating the turnbuckle housing 18 around the lower and upper right and left hand threaded rods 9 and 14 of the base 5 and mid-assembly 10 of turnbuckle 3.

A support bracket sleeve 30 is affixed to one end of the meter support plate 28 atop the upper locking housing 24. The support bracket sleeve 30 is preferably a hollow tube having a buttonhole 32 formed therein. A bracket handle 34 extends across the top of a preferably hollow filler tube 36. A spring-actuated pop-out, snap-in button 38 extends outwardly from one side of the filler tube 36. The filler tube 36 is sized and shaped to be slidably received by and ride through the support bracket sleeve 30 in response to a pushing force applied to the bracket handle 34. The filler tube 36 and the support bracket sleeve 30 are retained one inside the other when the pop-out button 38 of the filler tube 36 is spring-urged to snap into removable receipt by the buttonhole 32 in sleeve 30.

A pair of bolt holes 40 are formed through the meter support plate 28 of the upper locking housing 24. The bolt holes 40 are sized to accommodate therethrough the threaded opposite ends of a conventional U-bolt 42. Suitable fastener hardware (e.g., hex nuts, washers, etc.) is included by which to attach the threaded ends of U-bolt 42 to meter support plate 28 through bolt holes 40. With the U-bolt 42 attached to and standing upwardly from the meter support plate 28, the turnbuckle fire hydrant water meter stand 1 can be detachably connected to a fire hydrant water meter as will now be described.

Turning in this regard to FIG. 2 of the drawings, there is shown a fire hydrant 100 to which a water meter 200 has been coupled to measure the volume of water consumed by a user by way of the fire hydrant. The adjustable turnbuckle stand 1 of FIG. 1 is detachably connected to the outlet side of the water meter 200. The particular water meter 200 that is shown in FIG. 2 is commercially available and forms no part of the present invention. Briefly, the water meter 200 includes a universal swivel 202 at the inlet end thereof which is adapted to be rotated into mating engagement with the fire hydrant 100. The water meter 1 also includes a threaded water outlet 206 and a coupling ring 208 by which to couple a hose or the like (not shown) to the outlet 206 of water meter 100. The water meter 200 of FIG. 2 includes a backflow protection valve 210 to prevent the undesirable reverse flow of water through the fire hydrant 100 and towards the original municipal water supply. A gate valve 212 and a gate valve outlet 214 are located between the backflow valve 210 and the water outlet 206 of water meter 200.

According to a first preferred embodiment, the water meter stand 1 is detachably connected to the water meter 200 of FIG. 2 by locating the water meter support plate 28 of the upper locking housing 24 at the top of stand 1 behind the coupling ring 208 and below the gate valve outlet 214. The U-bolt 42 is attached to the water meter support plate 28 so as to lie over and in surrounding engagement with the gate valve outlet 214. The horizontal foot 7 of the turnbuckle base 5 at the bottom of the stand 1 will typically be laid upon a 2×6 support board (not shown). Nails may be inserted through nail holes 8 formed in the foot 7 to secure the foot against the support board. The support board will usually sit upon a cement block (also not shown) which lays upon the ground above which the water meter 200 is suspended.

As previously disclosed, the vertical length of the adjustable water meter stand 1 may be selectively adjusted between the foot 7 at the bottom of stand 1 and the meter support plate 28 at the top depending upon the dimensions of the fire hydrant 100 and the elevation of the water meter 200 coupled to the fire hydrant above the ground over which the foot 7 is positioned. That is, the pop-out button 16 extending from the hollow locking tube 12 of the turnbuckle mid-assembly 10 can be snapped into receipt by any one of the buttonholes 26 in the upper locking housing 24 in response to a downward pushing force applied to the meter support plate 28 to cause housing 24 to slide over locking tube 12. Additional vertical length adjustment of the stand 1 can be achieved, as previously described, by rotating the turnbuckle housing 18 of turnbuckle 3 around the lower and upper threaded rods 9 and 14 respectively connected to the turnbuckle base 5 and the turnbuckle mid-assembly 10. A rotation of the turnbuckle housing 18 will cause a corresponding linear displacement of the threaded rods 9 and 14 towards or away from one another through housing 18 and the lower and upper threaded collars 20 and 22 thereof.

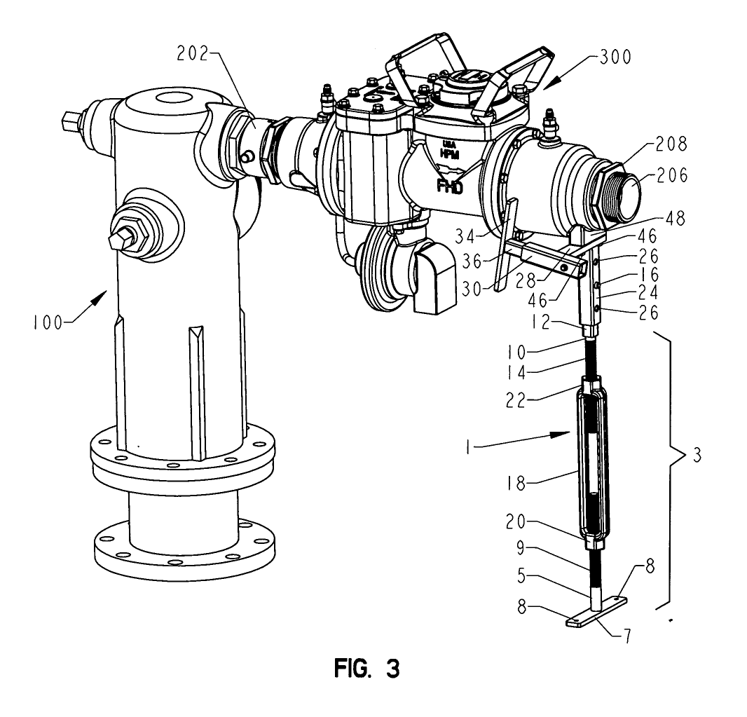

Another preferred embodiment by which the adjustable fire hydrant water meter stand 1 is detachably connected to a different water meter 300 is described while referring to FIG. 3 of the drawings. Like the water meter 200 of FIG. 2, the water meter 300 shown in FIG. 3 is commercially available and forms no part of this invention. Identical reference numerals have been used to identify identical parts of the water meters 200 and 300. By way of example only, each of the water meters 200 and 300 shown in FIGS. 2 and 3 is commercially available from Performance Meter of Beaumont, Calif.

Rather than detachably connect the water meter stand to the water meter 300 by means of the threaded U-bolt 42 of FIG. 2, threaded bolts 46 are shown in FIG. 3 inserted upwardly through the bolt holes (designated 40 in FIG. 1) formed in the water meter support plate 28 at the top of water meter stand 1. The threaded bolts 46 are mated to threaded holes (not shown) formed in a support block 48 that is affixed to the water meter 300 to lie between the outlet thereof and the meter support plate 28 of stand 1. The vertical length of the water meter stand 1 can be adjusted in the same manner as that previously described while referring to FIG. 2.

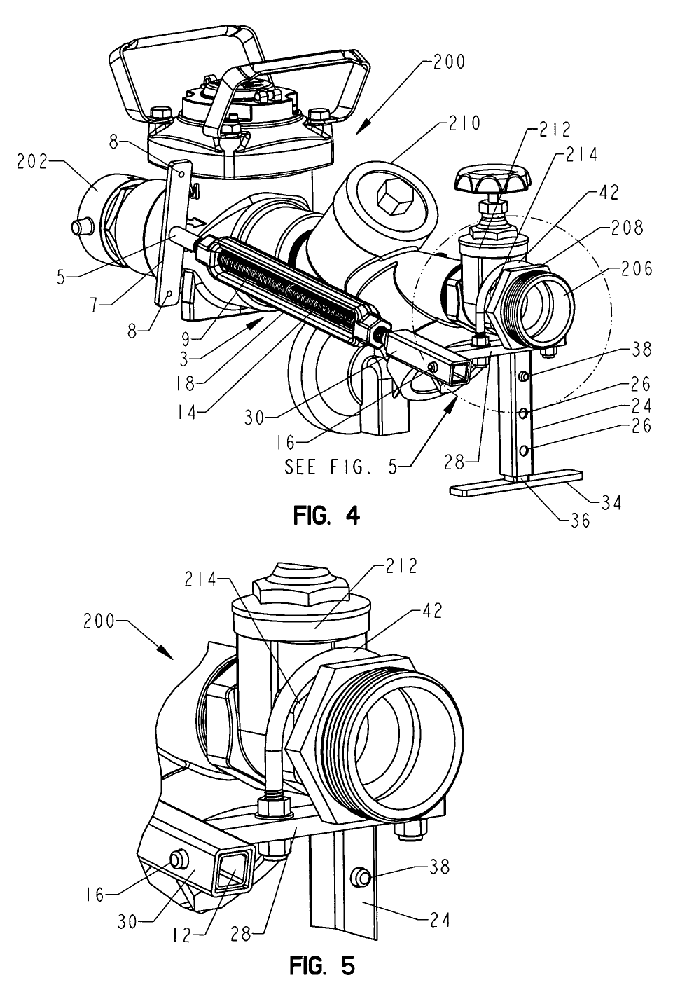

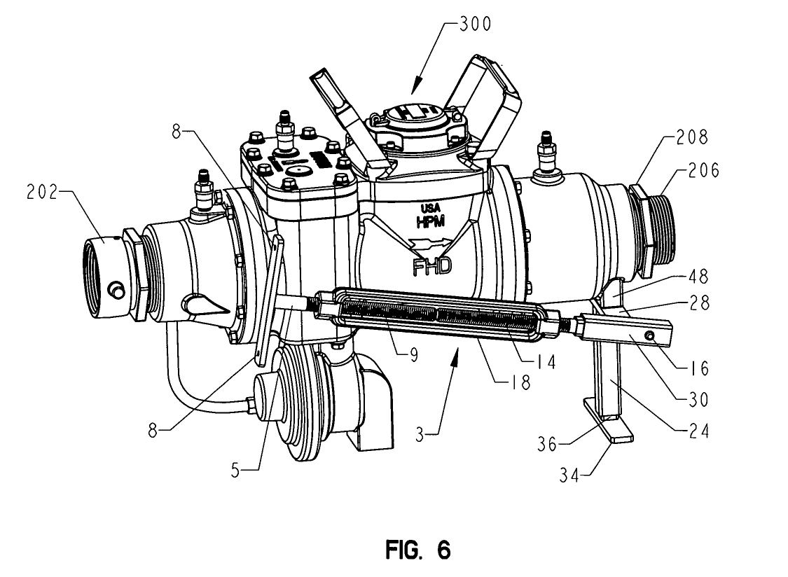

FIGS. 4-6 of the drawings show the adjustable turnbuckle fire hydrant water meter stand 1 carried by the water meters 200 and 300 of FIGS. 2 and 3 at those times when the water meters are held in storage or during shipment and use of the stand 1 is not required. FIGS. 4 and 5 illustrate a compact storage/shipping configuration for the water meter stand 1 and the water meter 200 of FIG. 2. The water meter support plate 28 of the upper locking housing 24 remains attached to the outlet end of the water meter 200 by means of the U-bolt 42 which extends over and in surrounding engagement with the gate valve outlet 214. However, the turnbuckle 3 is now separated from the upper locking housing 24. That is, the spring-actuated pop-out button 16 which extends from the hollow locking tube 12 of the turnbuckle mid-assembly 10 (best shown in FIG. 1) is pushed inwardly of its buttonhole 26 in the upper locking housing 24 so that tube 12 can be pulled out and separated from the locking housing 24. Similarly, the spring-actuated pop-out button 38 of the hollow filler tube 36 (also best shown in FIG. 1) is pushed inwardly of its buttonhole 32 formed in the support bracket sleeve 30. The filler tube 36 is pulled out and separated from the support bracket sleeve 30 in response to an outward pulling force applied to the bracket handle 34. The filler tube 36 is then pushed upwardly in response to a pushing force applied to handle 34 so as to be received by and slide through the upper locking housing 24 until the pop-out button 38 of filler tube 36 snaps into receipt by the top-most buttonhole 26 in the upper locking housing 24.

The adjustable turnbuckle 3 is now attached to the empty support bracket sleeve 30 so as to lie at an out-of-the-way location along a side of the water meter 200 (best shown in FIG. 4). That is, a pushing force applied to the foot 7 of the turnbuckle causes locking tube 12 of the turnbuckle mid-assembly 10 to be received by and slide inwardly through the support bracket sleeve 30 until the pop-out button 16 which extends from locking tube 12 is spring-urged to snap into receipt by the buttonhole 32 in the support bracket sleeve 30.

FIG. 6 illustrates the compact storage/shipping configuration of the water meter stand 1 and the water meter 300 of FIG. 3. The manner by which the turnbuckle 3 is removed from the upper locking housing 24 and then attached to the support bracket sleeve 30 so as to lie along a side of the water meter 300 is identical to that described while referring to FIGS. 4 and 5 and, therefore, will not be once again described. However, during storage and shipment, the water meter support plate 28 at the top of the upper locking housing 24 remains attached to support block 48 by means of the bolts 46 (of FIG. 3) rather than by the U-bolt 42 shown in FIGS. 4 and 5.

It may be appreciated that course adjustments to the length of the fire hydrant water meter stand 1 can be made by sliding the locking tube 12 of the turnbuckle mid-assembly 10 inwardly through the upper locking housing 24, and fine adjustments can be made by rotating the turnbuckle housing 18 of turnbuckle 3 to cause the opposing lower and upper threaded rods 9 and 14 to move with one another through the housing 18. Because of its selectively-adjustable nature, the water meter stand 1 of this invention can be used with almost any water meter regardless of the dimensions of the fire hydrant and elevation of the water meter that is coupled to the fire hydrant and suspended above the ground.

1. For a fire hydrant water meter that is coupled to a fire hydrant and suspended above the ground on which the fire hydrant is located, an adjustable water meter stand extending between the ground and the water meter, said adjustable water meter stand comprising:
a foot at one end of said stand to lay on the ground;
a meter support at the opposite end of said stand to be attached to the water meter; and
an intermediate body assembly located between said foot and said meter support, said intermediate body assembly including a hollow outer locking housing interconnected with said meter support and an inner locking member interconnected with said foot, said inner locking member being received by and slidable through said outer locking housing to correspondingly adjust the length of said stand between said foot and said meter support thereof, said inner locking member being detachably connected inwardly of said outer locking housing at a position depending upon the elevation of the water meter coupled to the fire hydrant and suspended above the ground.

2. The adjustable fire hydrant water meter stand recited in claim 1, further comprising fastener means by which to attach the meter support of said stand to the fire hydrant water meter.

3. The adjustable fire hydrant water meter stand recited in claim 2, wherein said fastener means includes bolts extending through said meter support for connection to the fire hydrant water meter.

4. The adjustable fire hydrant water meter stand recited in claim 2, wherein said fastener means includes a U-bolt located in surrounding engagement with the fire hydrant water meter, said U-bolt connected to said meter support.

5. The adjustable fire hydrant water meter stand recited in claim 1, wherein said intermediate body assembly also includes a turnbuckle located between the foot and the meter support of said stand, said turnbuckle being manipulated to further adjust the length of said stand between said foot and said meter support thereof.

6. The adjustable fire hydrant water meter stand recited in claim 5, wherein said turnbuckle includes a lower threaded rod interconnected with said foot, an upper threaded rod interconnected with the inner locking member of said intermediate body assembly, and a turnbuckle housing having lower and upper threaded collars to receive respective ones of said lower and upper threaded rods therein, said turnbuckle housing being rotated to correspondingly cause said upper and lower rods to move through said housing depending upon the elevation of the water meter coupled to the fire hydrant and suspended above the ground.

7. The adjustable fire hydrant water meter stand recited in claim 1, wherein the inner locking member of said intermediate body assembly includes a button projecting therefrom and the outer locking housing of said intermediate body assembly includes a series of axially-aligned buttonholes formed therein, said button being removably received by one of said series of buttonholes, whereby said inner locking member is detachably connected to said outer locking housing.

8. The adjustable fire hydrant water meter stand recited in claim 7, wherein the inner locking member of said intermediate body assembly is slidable outwardly of and removable from said outer locking housing thereof when said button is removed from the one of said series of buttonholes at times when said stand is not in use.

9. The adjustable fire hydrant water meter stand recited in claim 8, further comprising a hollow sleeve connected to said meter support, the inner locking member of said intermediate body assembly adapted to be slidably received by and detachably connected within said hollow sleeve after said inner locking member is first removed from said outer locking housing.

10. The adjustable fire hydrant water meter stand recited in claim 9, wherein said hollow sleeve includes a buttonhole formed therethrough, the button projecting from said inner locking member being removably received by the buttonhole of said sleeve, whereby said inner locking member is detachably connected to said sleeve.

11. The adjustable fire hydrant water meter stand recited in claim 8, further comprising a filler tube adapted to be slidably received by and detachably connected within the hollow outer locking housing of said intermediate body assembly after said inner locking member thereof is first removed from said outer locking housing.

12. For a fire hydrant water meter that is coupled to a fire hydrant and suspended above the ground on which the water meter is located, an adjustable water meter stand extending between the ground and the water meter, said adjustable water meter stand comprising:
a foot to lay on the ground;
a meter support to be attached to the water meter;
a hollow outer locking housing interconnected with said meter support;
an inner locking member received by and slidable through said hollow outer locking housing; and
a turnbuckle assembly including a turnbuckle housing, a threaded lower rod interconnected with said foot, and a threaded upper rod interconnected with said inner locking member,
said inner locking member moving through and being captured at a particular position within said outer locking housing and the turnbuckle housing of said turnbuckle assembly being rotated to cause said lower and upper threaded rods to move through said turnbuckle housing so as to correspondingly adjust the length of said water meter stand between said foot and said meter support thereof depending upon the elevation of the water meter coupled to the fire hydrant and suspended above the ground.
